(19) United States
(12) Patent Application Publication
(10) Pub. No.: US 2008/0112519 A1
(43) Pub. Date: May 15, 2008

(54) APPARATUS FOR RECEIVING MULTI-BAND SIGNALS OF MULTIPLE MODES AND METHOD THEREOF

(76) Inventors: Jae-Ho JUNG, Daejon (KR); Kwang-Chun LEE, Daejon (KR)

Correspondence Address: LADAS & PARRY LLP, 224 SOUTH MICHIGAN AVENUE, SUITE 1600, CHICAGO, IL, 60604, US

(21) Appl. No.: 11/876,884

(22) Filed: Oct. 23, 2007

(30) Foreign Application Priority Data
Nov. 14, 2006 (KR) 10-2006-0112381

(51) Int. Cl. H04B 1/10

(52) U.S. Cl. 375/350

(57) ABSTRACT

Provided are an apparatus for receiving multi-band signals of multiple modes and a method thereof. The apparatus includes a radio frequency (RF) pre-processing unit for receiving and pre-processing a RF input; a low noise amplifier (LNA) coupled to the RF pre-processing unit; an in-phase/quadrature-phase (IQ) frequency down-converter coupled to the LNA; a low pass filter (LPF) coupled to the IQ frequency down-converter; an analog-to-digital converter (ADC) coupled to the LPF; a complex frequency down-convertor for changing a digital local oscillation frequency based on a variation of center frequency of multi-mode baseband IQ signals converted in the ADC and converting multi-mode baseband IQ signals into baseband IQ signals of each mode; a variable digital filter for low-pass filtering the baseband IQ signals of each mode based on digital filter coefficients for filtering through a predetermined bandwidth; and a baseband signal processor for demodulating the baseband IQ signals of each mode.

### CROSS-REFERENCE TO RELATED APPLICATIONS

The present invention claims priority of Korean Patent Application No. 10-2006-0112381, filed on Nov. 14, 2006, which is incorporated herein by reference.

### BACKGROUND OF THE INVENTION

1. Field of the Invention

The present invention relates to an apparatus for receiving multi-band signals of multiple modes and a method thereof; and, more particularly, to an apparatus for receiving multi-band signals of multiple modes that can separate different communication or broadcasting services inputted as multi-mode signals into signals of each mode by using complex frequency down-converters and variable digital filters and demodulate the signals of each mode, and a method thereof.

This work was supported by the Information Technology (IT) research and development program of the Korean Ministry of Information and Communication (MIC) and the Korean Institute for Information Technology Advancement (IITA) [2005-S-016-02, “Development of Multimode Base Station”]

2. Description of Related Art

Multiple modes are a scheme which can support a plurality of different communication services or broadcasting services.

Recently, researchers have developed apparatuses for transmitting/receiving multi-mode signals adopting both a communication method of Code Division Multiple Access (CDMA) and a Global System for Mobile Communication (GSM) of a Time Division Multiple Access (TDMA) simultaneously. However, the apparatuses for receiving multi-mode signals simply supports the two services using fixed bandwidths by operating two receivers independently. In other words, the apparatuses can support only two services having specific bandwidths and they cannot be applied to services having variable frequency bandwidth.

Hereinafter, a conventional apparatus for receiving multi-band signals of multiple modes based on a double conversion method and a conventional apparatus for receiving multi-band signals of multiple modes based on a direct conversion method suggested for solving the above problems will be described.

FIG. 1 is a diagram illustrating a conventional apparatus for receiving signals of a single-mode based on a double conversion method.

As shown in FIG. 1, the conventional apparatus for receiving the signals of the single-mode based on the double conversion method includes an antenna 11, an RF pre-processing unit 12, e.g., an RF front-end, a low noise amplifier (LNA) 13, a local oscillator (LO) 14, a down-converting mixer 15, a band-pass filter (BPF) 16, an IQ frequency down-converter 17, low pass filter (LPF) 18, analog-to-digital converter (ADC) 19, and a baseband signal processor 20.

Hereinafter, the operation of the conventional apparatus for receiving the signals of a single mode based on the double conversion method will be described in detail. When the antenna 11 receives signals, the RF pre-processing unit 12 divides the radio frequency (RF) received signals into transmission signals and reception signals by filtering the received signals, and the LNA 13 amplifies small power of RF signal to high power of the RF signal. Then, the down-converting mixer 15 outputs an intermediate frequency (IF) signal by mixing the amplified RF signal in the LNA 13 and a signal outputted from the LO 14, and the BFP 16 performs filtering neighbor channel signals of the IF signal converted in the down-converting mixer 15.

Then, the IQ frequency down-converter 17 converts the filtered signal in the BFP 16 into baseband In-phase/Quadrature-phase (IQ) signals, and the LPF 18 performs filtering to eliminates spurious from the baseband IQ signals converted in the IQ frequency down-converter 17. Then, the ADC 19 converts the filtered basedband IQ signals into digital baseband IQ signals, respectively, and the baseband signal processor 20 demodulates the digital baseband IQ signals converted in the ADC 19.

The conventional apparatus for receiving signals based on the double conversion method requires a plurality of analog devices and cannot support a multi-mode service or a multi-band service.

FIG. 2 is a diagram illustrating a conventional apparatus for receiving multi-band signals of multiple modes based on a double conversion method.

As shown in FIG. 2, the conventional apparatus for receiving the multi-band signals of multiple modes based on the double conversion method includes an antenna 21, an RF pre-processing unit 22, e.g., an RF front-end, a low noise amplifier (LNA) 23, a plurality of local oscillators (LO) 24, a plurality of down-converting mixers 25, a plurality of band-pass filters (BPF) 26, a plurality of IQ frequency down-converters 27, a plurality of low pass filters (LPF) 28, a plurality of analog-to-digital converters (ADC) 29, and a plurality of baseband signal processors 30.

Hereinafter, the operation of the conventional apparatus for receiving the multi-band signals of multiple modes based on the double conversion method will be described in detail. When the antenna 21 receives signals, the RF pre-processing unit 22 divides the RF received signals into transmission signal and reception signal by filtering the received RF signals, and the LNA 23 amplifies small power of RF signal to high power of the RF signal. Then, each down-converting mixer 25 outputs an intermediate frequency (IF) signal having the same frequency by mixing the amplified RF signal in the LNA 23 and a signal outputted from each LO 24, and each BFP for multi-band 26 performs channel filtering the IF signal converted in the down-converting mixer 25 outputting multi-mode and the multi-band signals. Then, each IQ frequency down-converter 27 converts the filtered signal in the BFP 26 into baseband In-phase/Quadrature-phase (IQ) signals, and each LPF 28 performs filtering to eliminates spurious from the baseband IQ signals converted in the IQ frequency down-converter 27. Then, each ADC 29 converts the filtered basedband IQ signals into digital baseband IQ signals, respectively, and each baseband signal processor 30 demodulates the digital baseband IQ signals of each mode converted in each ADC 29, respectively.

The conventional apparatus for receiving the multi-band signals of multiple modes based on the double conversion method requires a plurality of wireless processing devices and baseband signal processing devices the same as the number of a plurality of frequency signals for simultaneous communication. Also, when the frequency bands are varied, a plurality of analog band pass filters has to be parallelized for channel filtering. Therefore, the structure of the apparatus becomes complex, and power consumption is increased. In addition, a scalability of the conventional apparatus for receiving the multi-band signals of multiple modes based on the double conversion method is not good.

FIG. 3 is a diagram illustrating a conventional apparatus for receiving signals of a single-mode based on a direct conversion method.

As shown in FIG. 3, the conventional apparatus for receiving the signals of the single-mode based on the direct conversion method includes an antenna 31, an RF pre-processing unit (an RF front-end) 32, a low noise amplifier (LNA) 33, an IQ frequency down-converter 34, low pass filter (LPF) 35, analog-to-digital converter (ADC) 36, and a baseband signal processor 37.

Hereinafter, the detail operation of the conventional apparatus for receiving the signals of the single-mode based on the direct conversion method will be described. When the antenna 31 receives signals, the RF pre-processing unit 32 divides the received RF signals into transmission signal and reception signal by filtering the received RF signals, and the LNA 33 amplifies small power of RF signal to high power of the RF signal. Then, the IQ frequency down-converter 34 converts the amplified RF signal in the LNA 33 into baseband In-phase/Quadrature-phase (IQ) signals directly, and the LPF 35 performs filtering to eliminates spurious from the baseband IQ signals converted in the IQ frequency down-converter 34. Then, the ADC 36 converts the filtered basedband IQ signals into digital baseband IQ signals, respectively, and the baseband signal processor 37 demodulates the digital baseband IQ signals converted in the ADC 36.

The conventional apparatus for receiving signals of the single-mode based on the direct conversion method can be easily applied to a terminal supporting multiple modes and multiple bands. Since the number of required analog devices is less than that of the conventional apparatus for receiving the signals of the single-mode based on the double conversion method, high integration and reliability can be ensured. However, the conventional apparatus for receiving the signals of the single-mode based on the direct conversion method requires a plurality of wireless processing devices the same as the number of a plurality of frequency signals for simultaneous communication, so that the structure of the receiving part becomes complex.

FIG. 4 is a diagram illustrating a conventional apparatus for receiving multi-band signals of multiple modes based on a direct conversion method.

As shown in FIG. 4, the conventional apparatus for receiving multi-band signals of multiple modes based on the direct conversion method includes an antenna 41, an RF pre-processing unit 42, e.g., an RF front-end, a low noise amplifier (LNA) 43, a plurality of IQ frequency down-converters 44, a plurality of low pass filters (LPF) 45, a plurality of analog-to-digital converters (ADC) 46, and a plurality of baseband signal processors 47.

Hereinafter, the operation of the conventional apparatus for receiving the multi-band signals of multiple modes based on the direct conversion method will be described in detail. When the antenna 41 receives signals, the RF pre-processing unit 42 divides the received RF signals into transmission signal and reception signal by filtering the received RF signals, and the LNA 43 amplifies small power of RF signal to high power of the RF signal. Then, each IQ frequency down-converter 44 converts the amplified RF signal in the LNA 43 into baseband In-phase/Quadrature-phase (IQ) signals, and each LPF 45 performs filtering to eliminates spurious from the baseband IQ signals converted in each IQ frequency down-converter 44. Then, each ADC 46 converts the basedband IQ signals filtered in each LPF 45 into digital baseband IQ signals, respectively, and the baseband signal processor 47 demodulates the digital baseband IQ signals of each mode converted in the ADC 46, respectively.

Although the conventional apparatus for receiving the multi-band signals of multiple modes based on the direct conversion method requires the number of analog devices less than that of the conventional apparatus for receiving the multi-band signals of multiple modes based on the double conversion method, a plurality of adjacent channel filters are needed. Also, when the number of multi-mode is changed, the number of reception routes cannot be changed.

### SUMMARY OF THE INVENTION

An embodiment of the present invention is directed to providing an apparatus for receiving multi-band signals of multiple modes that can separate different communication or broadcasting services inputted as multi-mode signals into signals of each mode by using complex frequency down-converters and variable digital filters and demodulate the signals of each mode, and a method thereof.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an aspect of the present invention, there is provided an apparatus for receiving multi-mode signals of multiple modes, including: a radio frequency (RF) pre-processing unit for receiving and pre-processing a RF input; a low noise amplifier (LNA) coupled to the RF pre-processing unit; an in-phase/quadrature-phase (IQ) frequency down-converter coupled to the LNA; a low pass filter (LPF) coupled to the IQ frequency down-converter; an analog-to-digital converter (ADC) coupled to the LPF; a complex frequency down-convertor for changing a digital local oscillation frequency based on a variation of center frequency of multi-mode baseband IQ signals converted in the ADC and converting multi-mode baseband IQ signals into baseband IQ signals of each mode; a variable digital filter for low-pass filtering the baseband IQ signals of each mode based on digital filter coefficients for filtering through a predetermined bandwidth; and a baseband signal processor for demodulating the baseband IQ signals of each mode filtered in the variable digital filter.

In accordance with another aspect of the present invention, there is provided a method for receiving multi-band signals of multiple modes, including: changing a digital local oscillation frequency based on a variation of center frequency of converted radio frequency (RF) signal of digital baseband in-phase/quadrature-phase (IQ) signals based on a direct conversion method and converting the digital baseband IQ signals into baseband IQ signals of each mode; low-pass filtering the baseband IQ signals of each mode based on digital filter coefficients for filtering through a predetermined bandwidth; and demodulating the baseband IQ signals of each mode.

In the present invention, signal reception and processing procedures are the same as those of the convention apparatus for receiving multi-band signals of multiple modes based on a direct conversion method. However, the present invention can support multiple modes having different center frequency by generating broadband baseband signals. Herein, each of the multiple modes can process multi-band signals.

### BRIEF DESCRIPTION OF THE DRAWINGS

FIG. 1 is a diagram illustrating a conventional apparatus for receiving signals of a single-mode based on a double conversion method.

FIG. 2 is a diagram illustrating a conventional apparatus for receiving multi-band signals of multiple modes based on a double conversion method.

FIG. 3 is a diagram illustrating a conventional apparatus for receiving signals of a single-mode based on a direct conversion method.

FIG. 4 is a diagram illustrating a conventional apparatus for receiving multi-band signals of multiple modes based on a direct conversion method.

FIG. 5 is a diagram illustrating an apparatus for receiving multi-band signals of multiple modes in accordance with an embodiment of the present invention.

FIG. 6A is a diagram showing conventional RF signals of a single-mode.

FIG. 6B is a diagram showing RF signals of multiple modes inputted into an apparatus for receiving multi-band signals of multiple modes in accordance with an embodiment of the present invention.

FIGS. 6C and 6D are diagrams showing signals processed in a complex frequency down-converter in accordance with an embodiment of the present invention.

FIG. 7 is a flowchart showing a method for receiving multi-band signals of multiple modes in accordance with an embodiment of the present invention.

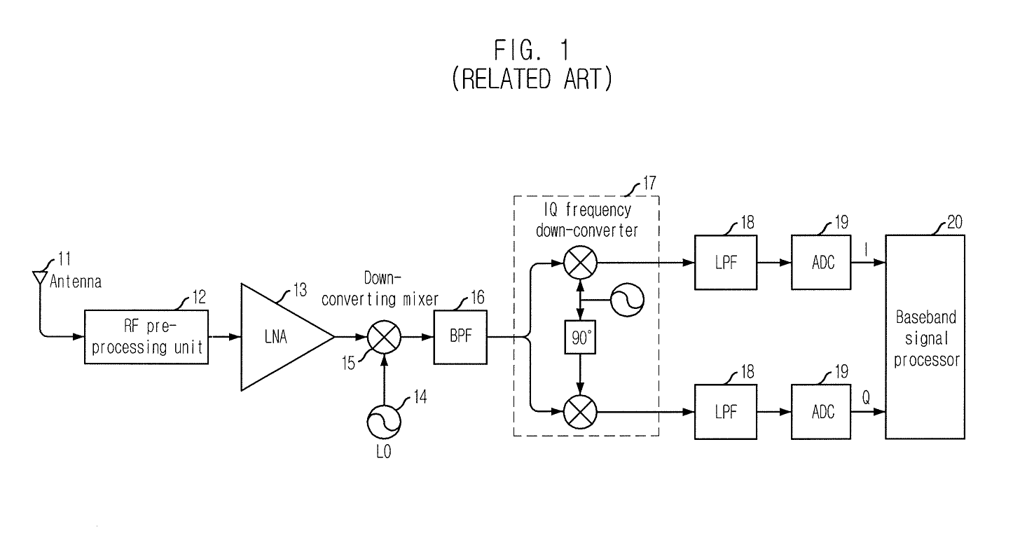

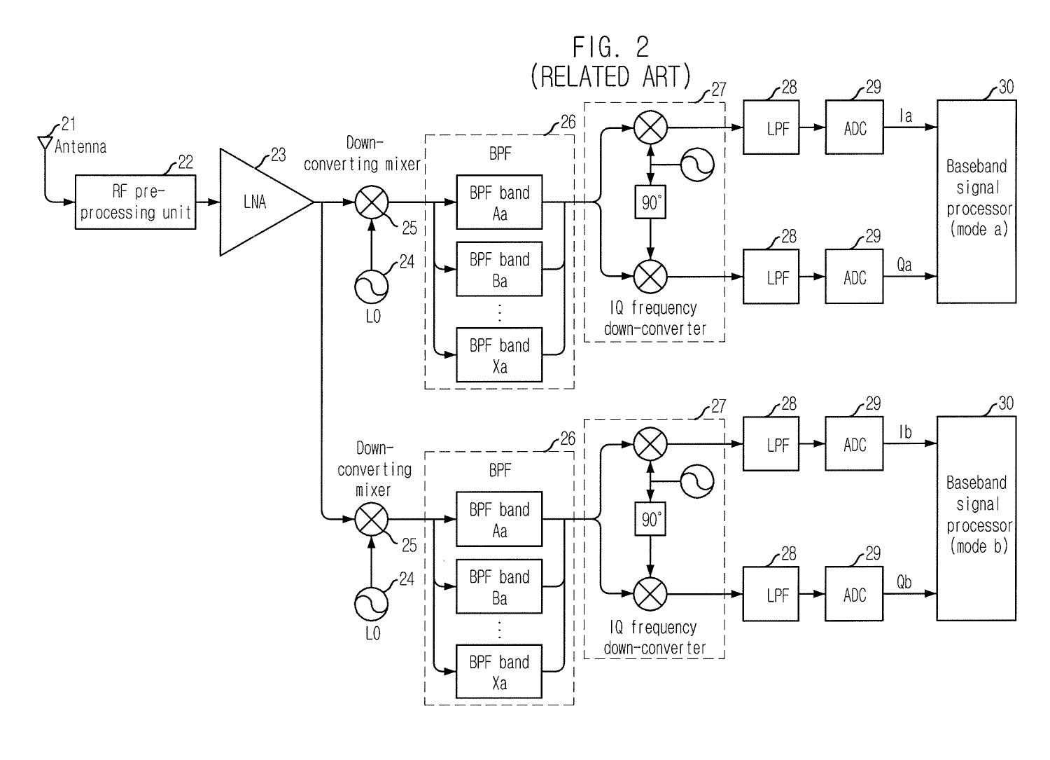

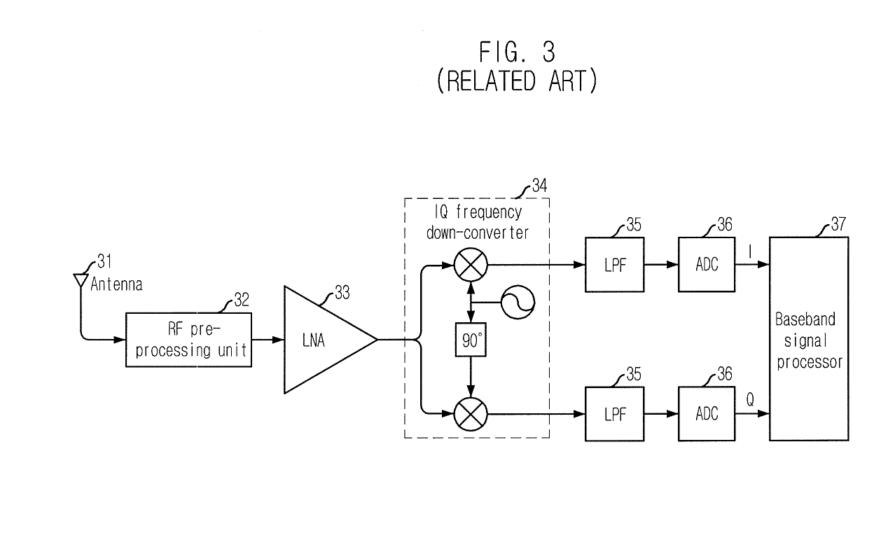

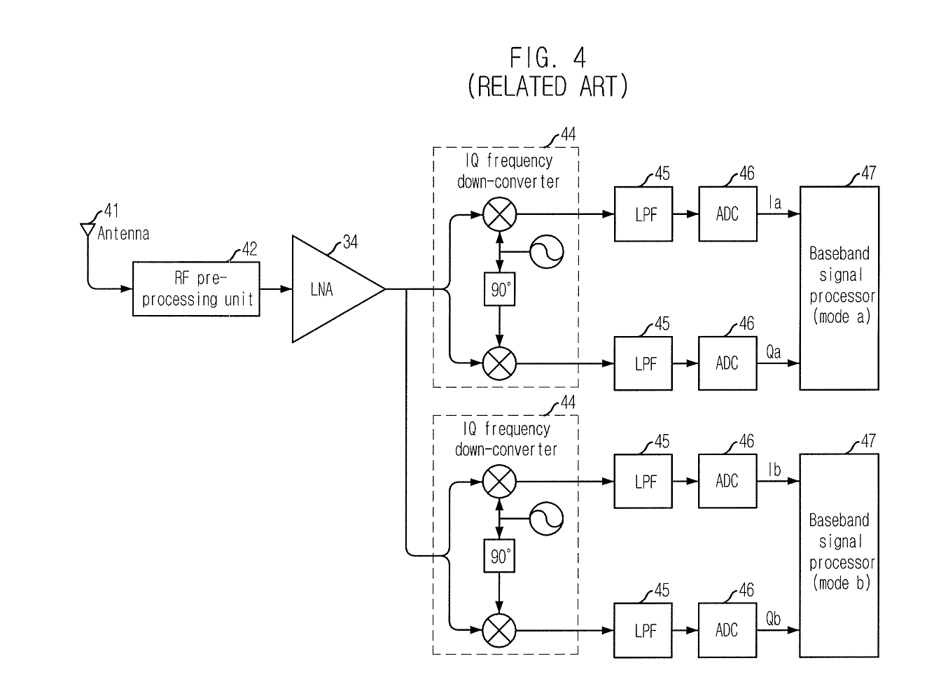

### DESCRIPTION OF SPECIFIC EMBODIMENTS

The advantages, features and aspects of the invention will become apparent from the following description of the embodiments with reference to the accompanying drawings, which is set forth hereinafter.

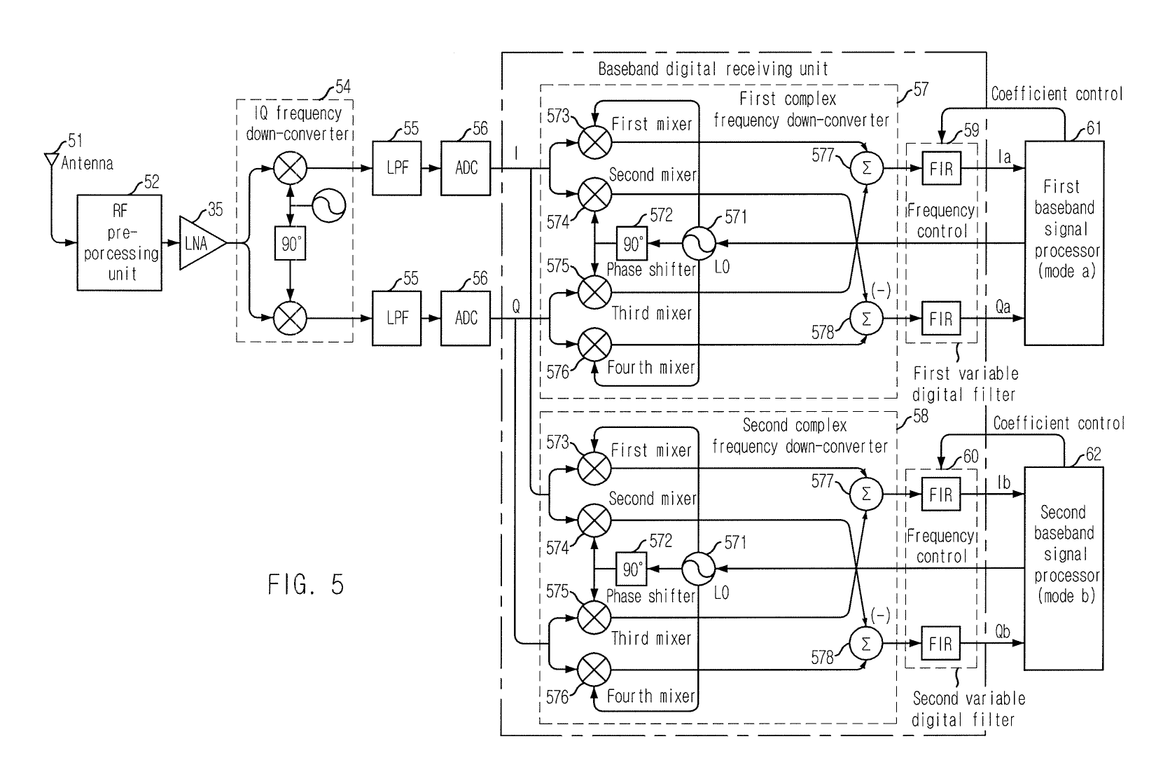

FIG. 5 is a diagram illustrating an apparatus for receiving multi-band signals of multiple modes in accordance with an embodiment of the present invention. It represents an apparatus for receiving multi-band signals of multiple modes based on a direct conversion method applying complex frequency down-converters.

As shown in FIG. 5, the apparatus for receiving multi-band signals of multiple modes in accordance with the present invention includes a broadband antenna 51, an RF pre-processing unit 52, e.g., an RF front-end, a low noise amplifier (LNA) 53, an IQ frequency down-converter 54, low pass filter (LPF) 55, analog-to-digital converter (ADC) 56, a first complex frequency down-converter 57, a second complex frequency down-converter 58, a first variable digital filter 59, a second variable digital filter 60, a first baseband signal processor (mode a) 61, which processes signals of mode a, and a second baseband signal processor (mode b) 62, which processes signals of mode b.

The broadband antenna 51 receives broadband RF signals, the RF pre-processing unit 52, e.g., an RF front-end, divides the received multi-mode RF signals into transmission signals and reception signals by filtering outside band of the received multi-mode RF signals, and the low noise amplifier (LNA) 53 amplifies small power of RF signals divided in the RF pre-processing unit to high power of the RF signals.

Then, the IQ frequency down-converter 54 converts the amplified multi-mode RF signal in the LNA 53 into baseband In-phase/Quadrature-phase (IQ) signals based on the direct conversion method, and each low pass filter (LPF) 55 performs filtering to eliminates spurious from multi-mode baseband IQ signals converted in IQ frequency down-converter 54, respectively.

Then, each analog-to-digital converter (ADC) 56 converts multi-mode basedband IQ signals filtered in each LPF 55 into digital multi-mode baseband IQ signals, respectively. Then, the first complex frequency down-converter 57 and the second complex frequency down-converter 58 convert multi-mode baseband IQ signals converted in each ADC 56 into digital baseband IQ signals of each mode, respectively.

Then, the first variable digital filter 59 and the second variable digital filter 60, i.e., finite impulse response (FIR) filter, perform low pass filtering digital baseband IQ signals of each mode based on digital filter coefficients for filtering a predetermined frequency band, respectively. Then, the first baseband signal processor (mode a) 61 and the second baseband signal processor (mode b) 62 demodulate the digital baseband IQ signals of each mode filtered in the variable digital filters 59 and 60, respectively.

Herein, the baseband IQ signals converted by the IQ frequency down-converter 54 have multi-mode signals, and the baseband IQ signals are received in a different frequency band for each mode.

Hereinafter, functions of the complex frequency down-converter 57 in the apparatus for receiving the multi-band signals of multiple modes will be described in detail.

The complex frequency down-converter 57 performs an operation expressed as the following Eq. 1 in order to generate an output complex signal I_{L}′+jQ_{L}′ in response to an input complex signal I_{L}+jQ_{L}.

I_{L}′+jQ_{L}′=(I_{L}+Q_{L})·e^{jω}^{_{N}}^{t}=(I_{L}+jQ_{L})·(cos ω_{N}t+sin ω_{N}t)=(I_{L}·cos ω_{N}t−Q_{L}·sin ω_{N}t)+j(I_{L}·sin ω_{N}t+Q_{L}·cos ω_{N}t) Eq. 1

A local oscillator 571 of the complex frequency down-converter 57 generates cos ω_{N}t corresponding to the frequency f_{N} and transmits cos ωn to a phase shifter 572, a first mixer 573 and a fourth mixer 576.

Then, the phase shifter 572 generates −sin ω_{N}t by 90° phase-shifting of cos ω_{N}t received from the local oscillator 571 and transmits −sin ω_{N}t to a second mixer 574 and a third mixer 575.

Then, the first mixer 573 multiplies a real component I_{L} of a signal inputted from the ADC 56 by cos ω_{N}t received from the local oscillator 571, and outputs a first real component I_{L}·cos ω_{N}t of an output complex signal.

Also, the second mixer 574 multiplies the real component I_{L} of the signal inputted from the ADC 56 by −sin ω_{N}t received from the phase shifter 572, and outputs a first imaginary component −I_{L}·sin ω_{N}t of the output complex signal.

Also, the third mixer 575 multiplies an imaginary component Q_{L} of the signal inputted from the ADC 56 by −sin ω_{N}t received from the phase shifter 572, and outputs a second real component −Q_{L}·sin ω_{N}t of the output complex signal.

Also, the fourth mixer 576 multiplies the imaginary component Q_{L} of the signal inputted from the ADC 56 by cos ω_{N}t received from the local oscillator 571, and outputs a second imaginary component Q_{L}·cos ω_{N}t of the output complex signal.

Also, an adder 577 and a subtractor 578 generate the output complex signal I_{L}′+jQ_{L}′ by combining the first real component I_{L}·cos ω_{N}t of the output complex signal received from the first mixer 573, the second imaginary component Q_{L}·cos ω_{N}t of the output complex signal received from the fourth mixer 576, the first imaginary component −I_{L}′ sin ω_{N}t of the output complex signal received from the second mixer 574 and the second real component −Q_{L}·sin ω_{N}t of the output complex signal received from the third mixer 575, and transmits the output complex signal I_{L}′+jQ_{L}′ to the baseband processor 61 or 62 through the digital variable filter 59 or 60, respectively.

The complex frequency down-converter 57 shifts frequency of signals received from the ADC 56 without distortion and outputs the frequency-shifted signals according to a mode as the above description.

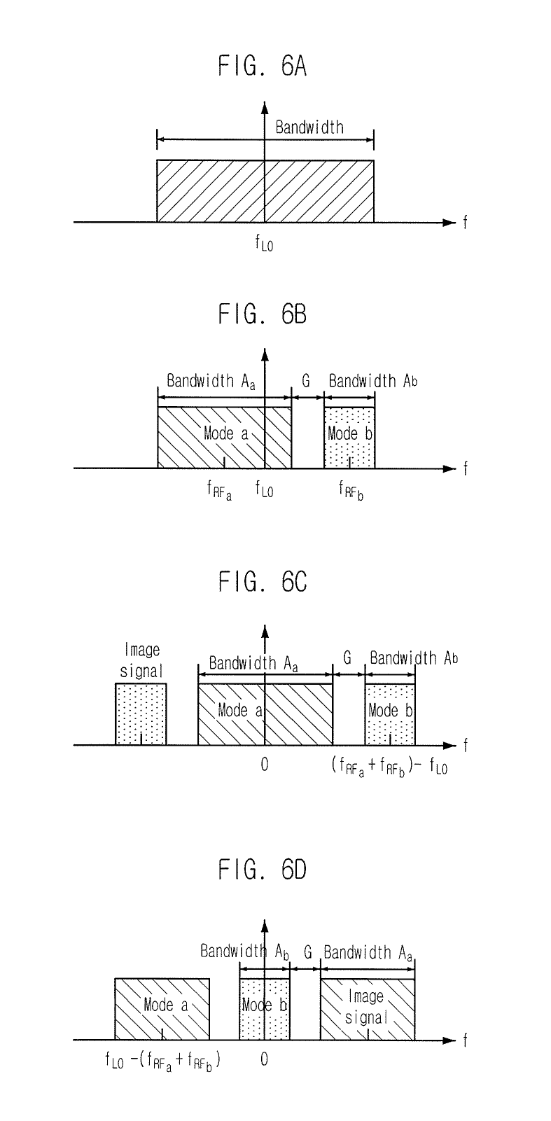

FIG. 6A is a diagram showing conventional RF signals of a single-mode.

When the apparatus for receiving the multi-band signals of multiple modes in accordance with the present invention receives the RF signals shown in FIG. 6A of the single-mode, the RF signals of the single-mode are processed by using one among a plurality of routes the same as the conventional method.

FIG. 6B is a diagram showing RF signals of multiple modes inputted into an apparatus for receiving multi-band signals of multiple modes in accordance with the present invention.

As shown in FIG. 6B, in modes of the RF signals, it is assumed that a ‘mode a’ occupies bandwidth Aₐ and a ‘mode b’ occupies bandwidth A_{b}, and a frequency gap between RF signals of the mode a and RF signals of the mode b is G.

The IQ frequency down-converter 54 outputs the baseband IQ signals by generating local oscillation frequency f_{LO} and mixing the RF signals and the local oscillation frequency based on the direct conversion method. The baseband IQ signals generated in the IQ frequency down-converter 54 are filtered in the LPF 55, converted into the digital baseband IQ signals and inputted to the complex frequency down-converter 54.

FIGS. 6C and 6D are diagrams showing signals processed in a complex frequency down-converter in accordance with the present invention.

The first complex frequency down-converter 57 down-converts digital baseband IQ signals converted in the ADC 56, i.e., signals of ‘mode a’, into signals of frequency ƒ_{LO}−ƒ_{RF}_{ₐ} to generate baseband IQ digital signals of ‘mode a’, referring to FIG. 6C.

Also, the second complex frequency down-converter 58 down-converts digital baseband IQ signals converted in the ADC 56, i.e., signals of ‘mode b’, into signals of frequency ƒ_{RF}_{_{b}}−f_{LO} to generate baseband IQ digital signals of ‘mode b’, referring to FIG. 6D.

The baseband IQ digital signals of each mode generated in the first complex frequency down-converter 57 and the second complex frequency down-converter 58 are filtered by using the low pass digital filters 59 and 60 having variable bandwidth, i.e., variable digital filters, respectively.

The first variable digital filters 59 performs low pass filtering signals of ‘mode a’ by adjusting the filter coefficients of the digital filter based on bandwidth Aₐ, and the second variable digital filters 60 performs low pass filtering signals of ‘mode b’ by adjusting the filter coefficients of the digital filter based on bandwidth A_{b}. Then, the variable digital filters 59 and 60 transmit filtered signals of each mode into the baseband signal processors 61 and 62, respectively.

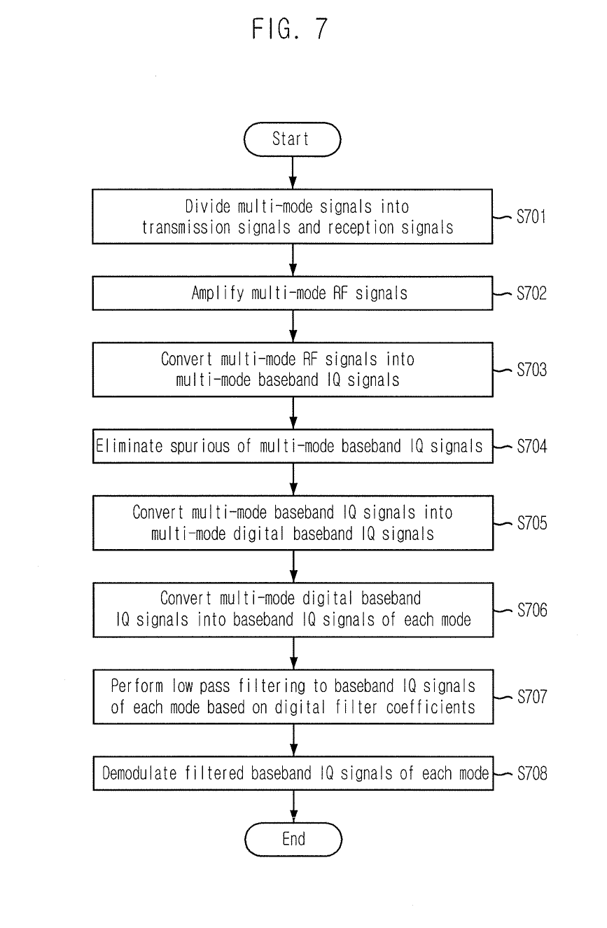

FIG. 7 is a flowchart showing a method for receiving multi-band signals of multiple modes in accordance with an embodiment of the present invention.

First, the RF pre-processing unit 52, e.g., an RF front-end, divides multi-mode RF signals received through the broadband antenna 51 into transmission signals and reception signals by filtering at step S701.

Then, the low noise amplifier (LNA) 53 amplifies small power of the received multi-mode RF signals divided in the RF pre-processing unit to high power of signals at step S702, and the IQ frequency down-converter 54 converts the amplified multi-mode RF signals in the LNA 53 into multi-mode baseband In-phase/Quadrature-phase (IQ) signals based on the direct conversion method at step S703.

Then, each low pass filter (LPF) 55 performs filtering to eliminates spurious from multi-mode baseband IQ signals converted in IQ frequency down-converter 54, respectively, at step 704, and each analog-to-digital converter (ADC) 56 converts multi-mode basedband IQ signals filtered in each LPF 55 into digital multi-mode baseband IQ signals, respectively, at step S705.

Then, the first complex frequency down-converter 57 and the second complex frequency down-converter 58 convert multi-mode baseband IQ signals converted in each ADC 56 into each mode digital baseband IQ signals, respectively, at step S706, the first variable digital filter 59 and the second variable digital filter 60 perform low pass filtering digital baseband IQ signals of each mode based on digital filter coefficients filtering a predetermined frequency band, respectively, at step S707.

Then, the first baseband signal processor (mode a) 61 and the second baseband signal processor (mode b) 62 demodulate the digital baseband IQ signals of each mode filtered in the variable digital filters 59 and 60, respectively, at step S708.

In the present invention, the number of routes of multi-mode can be controlled flexibly by dividing multi-mode signals into each mode signal based on the complex frequency down convert and the variable digital filter.

Also, the present invention can perform channel filtering of specific mode signals by adjusting the digital filter coefficients based on bandwidth of the multi-band.

Finally, the present invention can utilize an apparatus for receiving signals of single-mode based on a direct conversion method without changing structure thereof. Therefore, receiving part structure of the present invention is not complex and scalable.

The above described method according to the present invention can be embodied as a program and be stored on a computer readable recording medium. The computer readable recording medium is any data storage device that can store data which can be read by the computer system. The computer readable recording medium includes a read-only memory (ROM), a random-access memory (RAM), a CD-ROM, a floppy disk, a hard disk and an optical magnetic disk.

While the present invention has been described with respect to the specific embodiments, it will be apparent to those skilled in the art that various changes and modifications may be made without departing from the spirit and scope of the invention as defined in the following claims.

What is claimed is:

1. An apparatus for receiving multi-mode signals of multiple modes, comprising:
a radio frequency (RF) pre-processing unit for receiving and pre-processing a RF input;
a low noise amplifier (LNA) coupled to the RF pre-processing unit;
an in-phase/quadrature-phase (IQ) frequency down-converter coupled to the LNA;
a low pass filter (LPF) coupled to the IQ frequency down-converter;
an analog-to-digital converter (ADC) coupled to the LPF;
a complex frequency down-converting means for changing a digital local oscillation frequency based on a variation of center frequency of multi-mode baseband IQ signals converted in the ADC and converting multi-mode baseband IQ signals into baseband IQ signals of each mode;
a variable digital filtering means for low-pass filtering the baseband IQ signals of each mode based on digital filter coefficients for filtering through a predetermined bandwidth; and
a baseband signal processing means for demodulating the baseband IQ signals of each mode filtered in the variable digital filtering means.

2. The apparatus of claim 1, wherein the complex frequency down-converting means includes at least two complex frequency down-converting units to process each mode, and the variable digital filter means includes at least four variable digital filters to process in-phase signals and quadrature-phase signals of each mode.

3. The apparatus of claim 2, wherein the complex frequency down-converting means processes multi-mode baseband IQ signals converted in the ADC by separating the multi-mode baseband IQ signals into a real component and an imaginary component, and outputs a frequency-shifted complex signal by combining the processed real component and the imaginary component.

4. The apparatus of claim 3, wherein the complex frequency down converting unit includes:
a local oscillator for outputting a frequency varying based on a frequency control signal inputted from the baseband signal processing means;
a phase shifter for shifting phase of the frequency generated in the local oscillator;
a first mixer for combining a first real component of the signal inputted from the ADC and the frequency outputted from the local oscillator;
a second mixer for combining a second real component of the signal inputted from the ADC and the phase-shifted frequency outputted from the phase shifter;
a third mixer for combining a first imaginary component of the signal inputted from the ADC and the phase-shifted frequency outputted from the phase shifter;
a fourth mixer for combining a second imaginary component of the signal inputted from the ADC and the frequency outputted from the local oscillator;
a first adder for adding a first signal combined in the first mixer and a third signal combined in the third mixer; and
a second adder for adding a second signal combined in the second mixer and a fourth signal combined in the fourth mixer.

5. The apparatus of claim 1, wherein the digital filter coefficients of the variable digital filtering means are adjusted based on a bandwidth of multiple modes.

6. A method for receiving multi-band signals of multiple modes, comprising:
changing a digital local oscillation frequency based on a variation of center frequency of converted radio frequency (RF) signal of digital baseband in-phase/quadrature-phase (IQ) signals based on a direct conversion method and converting the digital baseband IQ signals into baseband IQ signals of each mode;
low-pass filtering the baseband IQ signals of each mode based on digital filter coefficients for filtering through a predetermined bandwidth; and
demodulating the baseband IQ signals of each mode.
